(19) United States
(12) Patent Application Publication
(10) Pub. No.: US 2026/0004467 A1
(43) Pub. Date: Jan. 1, 2026

(54) META-LEARNING-BASED JOINT SOURCE-CHANNEL CODING METHOD AND APPARATUS, AND MEDIUM

(71) Applicant: GUANGDONG POWER GRID CO., LTD., Guangzhou, Guangdong (CN)

(72) Inventor: Ying Sun, Guangzhou (CN)

(21) Appl. No.: 19/318,406

(22) Filed: Sep. 4, 2025

Related U.S. Application Data
(63) Continuation-in-part of application No. PCT/CN2024/140482, filed on Dec. 19, 2024.

(30) Foreign Application Priority Data
Jan. 19, 2024 (CN) 202410084583.4

(51) Int. Cl. G06T 9/00; G06N 3/045; G06N 3/084; G06N 3/0985

(52) U.S. Cl. CPC G06T 9/002; G06N 3/045; G06N 3/084; G06N 3/0985

(57) ABSTRACT

Provided are a meta-learning-based joint source-channel coding (JSCC) method and apparatus, and a medium. The method includes: obtaining a target image; performing JSCC on the target image through a preset target model to obtain a coding result; and transmitting the target image based on the coding result. The target model is obtained by performing inner-loop and outer-loop training on a preset neural network model based on a plurality of meta-learning tasks. The plurality of meta-learning tasks are constructed based on different average channel signal-to-noise ratios (SNRs). In the meta-learning-based JSCC method and apparatus, and the medium, JSCC is performed on the target image through the target model with excellent channel environment adaptability and image coding and transmission capabilities, to obtain the coding result for transmitting the target image. This can resolve a problem that effective image transmission is difficult under different channel conditions in few-shot scenarios.

### CROSS-REFERENCE TO RELATED APPLICATIONS

The present application is a Continuation-In-Part Application of PCT Application No. PCT/CN2024/140482 filed on Dec. 19, 2024, which claims the benefit of Chinese Patent Application No. 202410084583.4 filed on Jan. 19, 2024. All the above are hereby incorporated by reference in their entirety.

### TECHNICAL FIELD

The present disclosure relates to the field of communication technologies, and in particular, to a meta-learning-based joint source-channel coding (JSCC) method and apparatus, and a medium.

### BACKGROUND

JSCC is an important technology in wireless image transmission. It aims to integrate source coding and channel coding by jointly designing source coding and channel coding schemes, to implement high-quality image transmission when wireless channel bandwidth and transmission capacity are limited. Few-shot learning is an important research direction in the field of machine learning. To effectively utilize limited training samples, researchers have proposed many few-shot learning methods, aiming to learn generalized feature representations and models from limited samples to improve wireless image transmission performance in few-shot scenarios. Comprehensive utilization of a few-shot learning method, a source coding technology, a channel coding technology, and a joint optimization algorithm resolves a problem of wireless image transmission based on few-shot learning and improves image transmission reliability and efficiency.

However, in practical application, due to a limited quantity of samples required to train a neural network, performance of the neural network decreases under unknown channel conditions, resulting in impact on its generalization capability. In addition, because a communication channel is incorporated into a neural network architecture, the performance depends on accuracy of a channel model. In a complex or unstable communication environment, it is difficult for the model to accurately capture dynamic characteristics of the channel, thus affecting reliability of a communication system. Further, because a training set contains limited samples of specific channel conditions, the model's neural network overfits these conditions and underperforms under other channel conditions.

### SUMMARY

The present disclosure provides a meta-learning-based JSCC method and apparatus, and a medium, to resolve a problem that effective image transmission is difficult under different channel conditions in few-shot scenarios.

To resolve the foregoing problem, the present disclosure provides a meta-learning-based JSCC method, including:
obtaining a target image;
performing JSCC on the target image through a preset target model to obtain a coding result, where the target model is obtained by performing inner-loop and outer-loop training on a preset neural network model based on a plurality of meta-learning tasks, and the plurality of meta-learning tasks are constructed based on a plurality of average channel signal-to-noise ratios (SNRs); and
transmitting the target image based on the coding result.

In the present disclosure, JSCC is performed on the target image through the target model such that the coding result can be quickly obtained to transmit the target image. This JSCC method is simple, fast, and highly practical. Because the target model is obtained by performing inner-loop and outer-loop training on the preset model, an internal network parameter and a meta-parameter of the target model can be optimized and updated during training such that the target model fully learns connections and differences between information through limited training tasks, and has good image coding and transmission capabilities and adaptability. In this way, end-to-end training is performed on the neural network model based on the plurality of meta-learning tasks such that the obtained target model can rapidly adapt to different channel environments, and the image coding and transmission capabilities are further improved through the plurality of meta-learning tasks.

In comparison with the prior art, in the present disclosure, JSCC is performed on the target image through the target model with excellent channel environment adaptability and image coding and transmission capabilities, to obtain the coding result for transmitting the target image. This can avoid a problem that it is difficult for the model to accurately capture dynamic characteristics of a channel or overfitting occurs during coding, to resolve a problem that effective image transmission is difficult under different channel conditions in few-shot scenarios.

In a preferred solution, constructing the target model includes:
initializing an internal network parameter of the neural network model, and optimizing and updating an initialized internal network parameter based on a preset first loss function through a preset support set to obtain a first trained model;
optimizing and updating a meta-parameter of the first trained model based on a preset meta-loss function through a preset query set to obtain a second trained model;
training the second trained model through one of the plurality of meta-learning tasks to obtain a third trained model; and
iteratively updating an internal network parameter and a meta-parameter of the third trained model, and traversing the other meta-learning tasks in the plurality of meta-learning tasks through an optimized and updated third trained model to obtain the target model.

In this preferred solution, initializing the internal network parameter of the neural network model enables the neural network model to better generalize to a new task and concept. In addition, parameters of an inner loop are optimized and updated by observing data of the support set. These parameters pay more attention to details of specific tasks. This can help the neural network model learn more connections and differences between information in the meta-learning tasks, to enhance adaptability of the model.

In this preferred solution, in general, updating the internal network parameter and a meta-parameter of the neural network model through alternate training can continuously optimize the model and improve adaptability to new tasks with few samples. In this way, the finally obtained target model has good image coding and transmission capabilities and adaptability, such that the neural network model quickly adapts to different channel environments.

In a preferred solution, the optimizing and updating a meta-parameter of the first trained model based on a preset meta-loss function through a preset query set to obtain a second trained model is specifically as follows:
establishing the meta-loss function through a loss function of the meta-parameter of the first trained model on the query set; and
optimizing and updating the meta-parameter of the first trained model with an objective of minimizing the meta-loss function, to obtain the second trained model.

In this preferred solution, performance of the first trained model is optimized through the query set. Because the query set usually contains a plurality of tasks or concepts and encompasses a wide range of data information, calculating the meta-loss function on the query set and updating the parameter of the first trained model through the meta-loss function can reduce a loss of the obtained second trained model on the entire query set such that the second trained model has a good generalization capability.

In a preferred solution, the training the second trained model through one of the plurality of meta-learning tasks to obtain a third trained model specifically includes:
mapping a preset original input image onto a complex-valued channel input symbol of the one of the plurality of meta-learning tasks to obtain an output signal;
performing JSCC on the original input image through the second trained model to obtain a first coding result;
transmitting the output signal on a channel based on the first coding result to obtain corrupted output data;
performing approximate reconstruction of the original input image based on the corrupted output data to obtain a reconstructed image; and
modifying the second trained model based on the original input image and the reconstructed image to obtain the third trained model.

In this preferred solution, the third trained model is obtained by performing training and optimization through an actual meta-learning task. The output signal is transmitted on the channel in combination with the first coding result of the second trained model, and actual corrupted data may be obtained. Approximate reconstruction is performed based on the data. The obtained reconstructed image can reflect a difference between itself and the original input image such that the second trained model can be modified by using the two images as control groups, to optimize a coding capability of the third trained model.

In addition, performing training through an actual channel helps the model better capture dynamic characteristics of the channel, improves reliability of a communication system in a complex or unstable communication environment, and can reduce overfitting of the neural network model to specific channel conditions to improve robustness of the third trained model under various channel conditions.

In a preferred solution, constructing the plurality of meta-learning tasks includes:
establishing a joint transfer function through a preset channel fading transfer function and Gaussian channel transfer function;
determining the plurality of average channel SNRs based on an average power of a channel input signal and a plurality of preset noise variances; and
establishing the plurality of meta-learning tasks based on the joint transfer function and the plurality of average channel SNRs, where the plurality of average channel SNRs are in a one-to-one correspondence with the plurality of meta-learning tasks.

In this preferred solution, because a Rayleigh fading model is suitable for describing a wireless channel in a central area of a town with dense buildings, the plurality of meta-learning tasks can be rapidly constructed based on the channel fading transfer function and Gaussian channel transfer function in combination with the channel SNRs. This task construction method is simple and fast. In addition, the constructed meta-learning tasks encompass different channel conditions. This can facilitate adaptive training of the model, to improve a generalization capability of the model.

In a preferred solution, constructing the target model further includes:
fine-tuning the target model through a preset fine-tuning data set.

The fine-tuning includes at least one of learning rate adjustment, algorithm optimization, and regularization.

In this preferred solution, fine-tuning the target model enables the target model to better suit a task requirement of a dynamic channel environment, to improve a coding capability of the target model.

In a preferred solution, the fine-tuning the target model through a preset fine-tuning data set specifically includes:
initializing an internal network parameter of the target model based on a meta-parameter of the target model obtained after the training through the plurality of meta-learning tasks; and
iteratively updating the internal network parameter of the target model through the fine-tuning data set and a gradient descent algorithm.

The present disclosure further provides a meta-learning-based JSCC apparatus, including an obtaining module, a coding module, and a transmission module.

The obtaining module is configured to obtain a target image.

The coding module is configured to perform JSCC on the target image through a preset target model to obtain a coding result. The target model is obtained by performing inner-loop and outer-loop training on a preset neural network model based on a plurality of meta-learning tasks. The plurality of meta-learning tasks are constructed based on a plurality of average channel SNRs.

The transmission module is configured to transmit the target image based on the coding result.

In a preferred solution, the coding module includes an inner updating unit, an outer updating unit, a model training unit, and a model obtaining unit.

The inner updating unit is configured to initialize an internal network parameter of the neural network model, and optimize and update an initialized internal network parameter based on a preset first loss function through a preset support set to obtain a first trained model.

The outer updating unit is configured to optimize and update a meta-parameter of the first trained model based on a preset meta-loss function through a preset query set to obtain a second trained model.

The model training unit is configured to train the second trained model through one of the plurality of meta-learning tasks to obtain a third trained model. The plurality of meta-learning tasks are constructed based on a Rayleigh slow fading model and preset channel SNRs.

The model obtaining unit is configured to iteratively update an internal network parameter and a meta-parameter of the third trained model, and traverse the other meta-learning tasks in the plurality of meta-learning tasks through an optimized and updated third trained model to obtain the target model.

In a preferred solution, the outer updating unit includes a first updating subunit and a second updating subunit.

The first updating subunit is configured to establish the meta-loss function through a loss function of the meta-parameter of the first trained model on the query set.

The second updating subunit is configured to optimize and update the meta-parameter of the first trained model with an objective of minimizing the meta-loss function, to obtain the second trained model.

In a preferred solution, the model training unit includes a first training subunit, a second training subunit, a third training subunit, a fourth training subunit, and a fifth training subunit.

The first training subunit is configured to map a preset original input image onto a complex-valued channel input symbol of the one of the plurality of meta-learning tasks to obtain an output signal.

The second training subunit is configured to perform JSCC on the original input image through the second trained model to obtain a first coding result.

The third training subunit is configured to transmit the output signal on a channel based on the first coding result to obtain corrupted output data.

The fourth training subunit is configured to perform approximate reconstruction of the original input image based on the corrupted output data to obtain a reconstructed image.

The fifth training subunit is configured to modify the second trained model based on the original input image and the reconstructed image to obtain the third trained model.

In a preferred solution, the coding module further includes a task construction unit. The task construction unit includes a first construction subunit, a second construction subunit, and a third construction subunit.

The first construction subunit is configured to establish a joint transfer function through a preset channel fading transfer function and Gaussian channel transfer function.

The second construction subunit is configured to determine the plurality of average channel SNRs based on an average power of a channel input signal and a plurality of preset noise variances.

The third construction subunit is configured to establish the plurality of meta-learning tasks based on the joint transfer function and the plurality of average channel SNRs. The plurality of average channel SNRs are in a one-to-one correspondence with the plurality of meta-learning tasks.

In a preferred solution, the coding module further includes a fine-tuning unit. The fine-tuning unit is configured to:
fine-tune the target model through a preset fine-tuning data set.

The fine-tuning includes at least one of learning rate adjustment, algorithm optimization, and regularization.

In a preferred solution, the fine-tuning unit is specifically configured to:
initialize an internal network parameter of the target model based on a meta-parameter of the target model obtained after the training through the plurality of meta-learning tasks; and
iteratively update the internal network parameter of the target model through the fine-tuning data set and a gradient descent algorithm.

The present disclosure further provides a non-transitory computer-readable storage medium. The non-transitory computer-readable storage medium stores a computer program. The computer program is invoked and executed by a computer to implement the foregoing meta-learning-based JSCC method.

### BRIEF DESCRIPTION OF THE DRAWINGS

FIG. 1 is a schematic flowchart of a meta-learning-based JSCC method according to an embodiment of the present disclosure;

FIG. 2 is a system architecture diagram of a meta-learning-based deep JSCC scheme according to an embodiment of the present disclosure;

FIG. 3 is a diagram of algorithm convergence according to an embodiment of the present disclosure;

FIG. 4 is a comparison diagram of impact of a quantity of training samples on image transmission performance according to an embodiment of the present disclosure;

FIG. 5 is a diagram of a relationship between a channel environment and image transmission performance according to an embodiment of the present disclosure;

FIG. 6 is a schematic structural diagram of a meta-learning-based JSCC apparatus according to an embodiment of the present disclosure;

FIG. 7 is a schematic structural diagram of a meta-learning-based JSCC apparatus according to an embodiment of the present disclosure;

FIG. 8 is a schematic structural diagram of a meta-learning-based JSCC apparatus according to an embodiment of the present disclosure;

FIG. 9 is a schematic structural diagram of an outer updating unit according to an embodiment of the present disclosure;

FIG. 10 is a schematic structural diagram of a model training unit according to an embodiment of the present disclosure;

FIG. 11 is a schematic structural diagram of a task construction unit according to an embodiment of the present disclosure; and

FIG. 12 is a schematic structural diagram of a fine-tuning unit according to an embodiment of the present disclosure.

### DETAILED DESCRIPTION

The technical solutions in the embodiments of the present application are clearly and completely described below with reference to the accompanying drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

In the description of the present application, it should be understood that the terms “first”, “second”, . . . , and “fifth” are used merely for a descriptive purpose, and should not be construed as indicating or implying relative importance, or implicitly indicating a quantity of indicated technical features. Therefore, features defined with “first”, “second”, . . . , and “fifth” may explicitly or implicitly include one or more such features. In the description of the present application, unless otherwise specified, “a plurality of” means two or more.

A meta-learning-based JSCC method described in the embodiments of the present disclosure is mainly applied to wireless image transmission scenarios, especially when there are few training samples for a model. Through this solution, limited samples can be fully utilized to train the model, to improve image transmission reliability and efficiency for the model.

In the description of the present application, it should be noted that SNR is short for signal-to-noise ratio.

### Embodiment 1

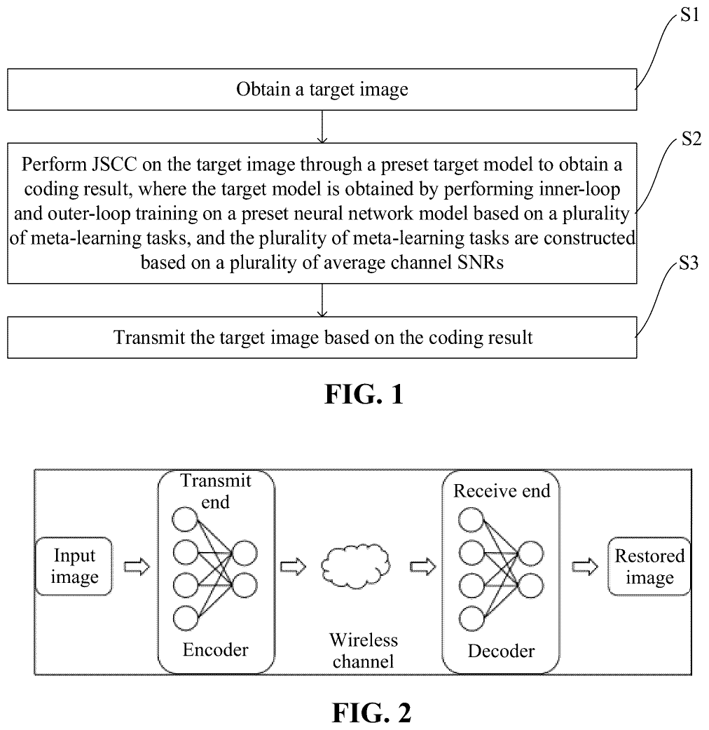

Referring to FIG. 1, an embodiment of the present disclosure provides a meta-learning-based JSCC method, including S1 to S3. Specific implementation steps are as follows:

S1: Obtain a target image.

In this embodiment of the present disclosure, S1 is specifically as follows:

Obtain the target image, where the target image is an image to be wirelessly transmitted.

S2: Perform JSCC on the target image through a preset target model to obtain a coding result. The target model is obtained by performing inner-loop and outer-loop training on a preset neural network model based on a plurality of meta-learning tasks. The plurality of meta-learning tasks are constructed based on a plurality of average channel SNRs.

In this embodiment of the present disclosure, S2 is specifically as follows:

Perform JSCC on the target image through the preset target model to obtain the coding result.

A process of constructing the target model includes S2.1 to S2.6, which are specifically as follows:

S2.1: Establish a joint transfer function through a preset channel fading transfer function and Gaussian channel transfer function.

Determine the plurality of average channel SNRs based on an average power of a channel input signal and a plurality of preset noise variances. Specifically, the average channel SNRs are obtained by changing a noise variance σ² such that the average channel SNRs are 0 dB, 5 dB, 10 dB, 15 dB, and 20 dB.

Establish the plurality of meta-learning tasks based on the joint transfer function and the plurality of average channel SNRs. The plurality of average channel SNRs are in a one-to-one correspondence with the plurality of meta-learning tasks.

The joint transfer function is as follows:

$$η ( z ) = {η}_{n} ( {η}_{h} ( z ) ) = hz + n$$

A multiplicative effect of a channel gain on a transmitted signal is captured by a channel fading transfer function ηₕ(z)=hz (namely a Rayleigh fading model). h˜ [symbol] (0, H_{c}) is a complex normal random variable. h represents the channel gain. z represents the transmitted signal. n represents Gaussian noise. H_{c} is a covariance matrix of the channel gain h, which contains power and correlation information of all dimensions of a channel, and is a key parameter of a channel statistical model. The Gaussian channel transfer function is ηₙ(z)=z+n. n˜ [symbol] (0,σ²I_{b}) represents noise. σ² represents a noise power or noise variance, namely average energy of each noise component, reflecting a noise intensity. I_{b} is a b-dimensional identity matrix, representing isotropic white noise.

The average channel SNR is calculated through the following formula:

$$SNR = 10 {log}_{10} \frac{P}{{σ}^{2}}$$

P represents the average power of the channel input signal after a power normalization layer is applied to an encoder. P=1. SNR is expressed in decibels (dB).

A channel in each training task constructed in this embodiment is a Rayleigh slow fading model. Because the Rayleigh fading model is suitable for describing a wireless channel in a central area of a town with dense buildings, the plurality of meta-learning tasks (namely training tasks) can be rapidly constructed based on the channel fading transfer function and Gaussian channel transfer function in combination with the average channel SNRs. This task construction method is simple and fast. In addition, the constructed meta-learning tasks encompass different channel conditions. This can facilitate adaptive training of the model, to improve a generalization capability of the model.

S2.2: Update an internal network parameter of the preset neural network model through an inner loop, that is, initialize the internal network parameter θ of the preset model through a meta-parameter ϕ at the beginning of each inner loop, and optimize and update an initialized internal network parameter based on a preset first loss function through a preset support set by using an Adaptive Moment Estimation (Adam) optimizer, to obtain a first trained model.

The first loss function is as follows:

$$ℒ = \frac{1}{N} {\sum }_{i = 1}^{N} d ( {x}_{i} , {\hat{x}}_{i} )$$

$$d ( {x}_{i} , {\hat{x}}_{i} ) = \frac{1}{n} {‖ {x}_{i} - {\hat{x}}_{i} ‖}^{2}$$

represents a mean square error (MSE) distortion. xᵢ is a sample i in the support set. \hat{x}ᵢ is an estimate of the sample i. N is a quantity of samples. n is a quantity of pixels in xᵢ.

A specific process of optimizing and updating the initialized internal network parameter is as follows: For an internal network parameter θⱼ of the j^{th} meta-learning task in the plurality of meta-learning tasks in the inner loop, calculate a gradient through the first loss function [symbol] , and update the internal network parameter θⱼ based on an average value of the calculated gradient and a historical gradient for the internal network parameter through a gradient descent method by using the Adam optimizer.

The foregoing process of updating the internal network parameter θⱼ may be expressed as follows:

$${θ}_{j} ← {θ}_{j} - β {∇}_{{θ}_{j}} {ℒ}_{{D}_{sup} ( j )} ( {θ}_{j} )$$

∇₇₄ _{ⱼ} [symbol] _{D}_{ₛᵤₚ}₍ⱼ₎(θⱼ) represents a gradient of a loss function [symbol] _{D}_{ₛᵤₚ}₍ⱼ₎(θⱼ) for the parameter θⱼ in the inner loop. D_{Sup}(j) is a support set of the j^{th} task. β is a learning rate of the inner loop. θⱼ is the internal network parameter of the j^{th} task.

It should be noted that the preset neural network model is a neural network model constructed based on the meta-parameter ϕ and the internal network parameter θ.

The meta-parameter ϕ is a global parameter in an entire meta-learning process and is optimized in an outer loop of meta-learning. The meta-parameter ϕ is responsible for learning common data information from the plurality of meta-learning tasks, enabling rapid adaptation to a new task or environment. The meta-parameter ϕ is specifically a parameter of a convolutional layer, batch normalization layer, and fully connected layer in the neural network model. Meta-parameter also known as external network parameter.

The internal network parameter θ is specific to a single training task and is optimized in an inner loop of meta-learning. In each specific task (image transmission task at a specific channel SNR), the internal network parameter θ is rapidly adjusted to suit a requirement of the task. The internal network parameter θ is derived from the meta-parameter ϕ and optimized for the specific task.

In this embodiment, initializing the internal network parameter of the neural network model enables the neural network model to better generalize to a new task and concept. In addition, parameters of the inner loop are optimized and updated by observing data of the support set. These parameters pay more attention to details of specific tasks. This can help the neural network model learn more connections and differences between information in the training tasks, to enhance adaptability of the model.

S2.3: Update a meta-parameter through an outer loop, that is, establish a meta-loss function through a loss function of a meta-parameter ϕ of the first trained model on a query set after performing one of the plurality of meta-learning tasks.

Optimize and update the meta-parameter of the first trained model with an objective of minimizing the meta-loss function, to obtain a second trained model.

Minimizing the meta-loss function is as follows:

$${min}_{ϕ} {ℒ}_{meta} ( ϕ ) = {\sum }_{j ∈ ℋ} {ℒ}_{{D}_{Que} ( j )} ( {θ}_{j} )$$

[symbol] ₘₑₜₐ is a loss function associated with a specific parameter (namely the internal network parameter) θ to a meta-learning task on the query set. θⱼ is an optimized internal network parameter obtained after performing the j^{th} meta-learning task. [symbol] _{D}_{_{Que}}₍ⱼ₎ is the loss function on the query set. j is an ordinal number of the meta-learning task. [symbol] is a total quantity of meta-learning tasks.

In this embodiment, performance of the first trained model is optimized through the query set. Because the query set usually contains a plurality of tasks or concepts and encompasses a wide range of data information, calculating the meta-loss function on the query set and updating the parameter of the first trained model through the meta-loss function can reduce a loss of the obtained second trained model on the entire query set such that the second trained model has a good generalization capability.

S2.4: Map a preset original input image x (x∈R^{m}) onto a complex-valued channel input symbol z (namely the transmitted signal) (z∈C^{b}) of a first meta-learning task in the plurality of meta-learning tasks to obtain an output signal z′. A size of the original input image x is H (height)×W (width)×C (quantity of channels). m=H×W×C. R represents a real number set. C represents the quantity of channels. b represents a size of a channel input symbol (namely the complex-valued channel input symbol z).

Perform JSCC on the original input image through the second trained model to obtain a first coding result.

Transmit the output signal z′ on a channel based on the first coding result to obtain corrupted output data.

Perform approximate reconstruction of the original input image based on the corrupted output data to obtain a reconstructed image \hat{x} (\hat{x}∈R^{m}).

Modify the second trained model based on the original input image and the reconstructed image to obtain a third trained model.

In specific implementation, the original input image x may be obtained from, for example, a Canadian Institute for Advanced Research (CIFAR)-10 image data set. Certainly, it may alternatively be obtained from another image data set. More details are not described herein.

To apply this embodiment of the present disclosure, refer to FIG. 2. FIG. 2 is a system architecture diagram of a meta-learning-based deep JSCC scheme, providing a specific process of reconstructing an image. A changing transmission channel environment is simulated by establishing a wireless image transmission system in a plurality of channel environments and setting channel SNRs. The wireless image transmission system is designed through a JSCC technology. Specifically, an encoder combined with the second trained model is deployed at a transmit end, and is responsible for performing source coding and channel coding on the original input image x, converting image data into coded data suitable for transmission, and performing compression coding on the image. A wireless communication channel is modeled as a series of untrainable layers incorporated into an entire neural network architecture. A decoder is disposed at a receive end to invert the encoder's operations through a series of transposed convolutional layers (the transposed convolutional layers are followed by a non-linear activation function) to restore the image and obtain the reconstructed image \hat{x}.

In this embodiment, the third trained model is obtained by performing training and optimization through actual training tasks. The original input image x is mapped onto the complex-valued channel input symbol z, and then the output signal z′ is transmitted on the channel. In this way, an amplitude and frequency distribution of an image signal can be controlled within a proper range, to reduce required bandwidth and improve transmission efficiency in terms of SNRs. In addition, because the complex-valued channel input symbol z can counteract impact of channel noise through phase adjustment, transmission reliability can be improved.

The output signal is transmitted on the channel in combination with the first coding result of the second trained model, and actual corrupted data may be obtained. Approximate reconstruction is performed based on the data. The obtained reconstructed image can reflect a difference between itself and the original input image such that the second trained model can be modified by using the two images as control groups, to optimize a coding capability of the third trained model.

In addition, performing training through an actual channel helps the model better capture dynamic characteristics of the channel, improves reliability of a communication system in a complex or unstable communication environment, and can reduce overfitting of the neural network model to specific channel conditions to improve robustness of the third trained model under various channel conditions.

S2.5: Iteratively update an internal network parameter and a meta-parameter of the third trained model, and traverse the other meta-learning tasks in the plurality of meta-learning tasks through an optimized and updated third trained model until the meta-loss function [symbol] ₘₑₜₐ converges, to obtain a preliminary target model.

S2.6: Fine-tune the target model through a preset fine-tuning data set. The fine-tuning includes at least one of learning rate adjustment, algorithm optimization, and regularization.

In this embodiment, step S2.6 “fine-tune the target model through a preset fine-tuning data set” specifically includes:
initialize an internal network parameter of the target model based on a meta-parameter of the target model obtained after the training through the plurality of meta-learning tasks; and
iteratively update the internal network parameter of the target model through the fine-tuning data set and a gradient descent algorithm.

Specifically, an internal network parameter θₖ in a preset channel environment with a specific target channel SNR is initialized through the meta-parameter ϕ obtained after meta-learning. The parameter θₖ is a model parameter corresponding to image transmission for the target model in a new target environment.

θₖ is adaptively fine-tuned again on the fine-tuning data set (namely a preset adaptive data set D_{Ad}(k)) through the gradient descent method, to obtain a further improved target model, which is also referred to as a deep JSCC model.

The foregoing process of fine-tuning and optimizing the parameter θₖ may be expressed as follows:

$${θ}_{k} ← {θ}_{k} - γ {∇}_{{θ}_{k}} {ℒ}_{{D}_{Ad} ( k )} ( {θ}_{k} )$$

γ represents a learning rate of the target model in a target environment. [symbol] _{Ad(k)}(θₖ) represents a loss function on D_{Ad}(k). ∇_{θ}_{ₖ} [symbol] _{D}_{_{Ad}}₍ₖ₎(θₖ) represents a gradient of the loss function [symbol] _{Ad(k)}(θₖ) for the parameter θₖ.

In specific implementation, the adaptive data set D_{Ad}(k) may be obtained from, for example, a CIFAR-10 image data set. Certainly, it may alternatively be obtained from another image data set. More details are not described herein. In addition, in actual application, training of the internal network parameter requires only the internal network parameter to be iteratively updated. Parameter updating of an inner network needs to be fed back to an outer network, and then the meta-parameter is iteratively updated, to obtain a better network initialization parameter.

It should be noted that performance of the foregoing deep JSCC algorithm and all benchmark schemes is quantized based on a peak SNR (PSNR). A PSNR index measures a ratio between a maximum possible power of a signal and a noise power of an interference signal, specifically expressed as follows:

$$PSNR = 10 {log}_{10} \frac{{MAX}^{2}}{MSE}$$

MSE=d (x,\hat{x}) is an MSE between the original input image x and the reconstructed image \hat{x}. MAX is a maximum possible value of an image pixel. MAX=2⁸−1=255 for an RGB image.

For S2.2 to S2.5 in this embodiment, in general, initializing the parameters of the inner loop through parameters of the outer loop enables the model to better generalize to a new task or concept. The parameters of the outer loop are adjusted on a larger query set through a global optimization algorithm. These parameters include the generalization capability of the model on various tasks. The parameters of the inner loop are updated by observing the data of the support set. These parameters pay more attention to the details of specific tasks. Updating the internal network parameter and the meta-parameter of the neural network model through alternate training can continuously optimize the model and improve adaptability to new tasks with few samples. In this way, the finally obtained target model has good image coding and transmission capabilities and adaptability, and can be used for subsequent training of the neural network model, such that the neural network model quickly adapts to different channel environments.

In addition, in this embodiment, S2.1 to S2.5 are a pre-training phase of the target model, and S2.6 is a fine-tuning phase of the target model. The meta-learning tasks are constructed through different average channel SNRs. In each meta-learning task, parameters of the preset neural network model are initialized to a group of random parameters θⱼ. Then, a meta-learning algorithm is used for iterative training such that the neural network model can perform fast learning and parameter updating through few sample tasks. In each iteration, the neural network model calculates a gradient based on sample tasks for a current task and updates model parameters through an optimization algorithm such as gradient descent. A plurality of iterations are repeated until the model converges or a predetermined quantity of training rounds is reached.

At the end of the pre-training phase, the meta-parameter of a pre-trained target model is stored for subsequent fine-tuning and testing. Through the fine-tuning phase in S2.6, the target model can perform parameter updating in the new target environment to have a more reliable image transmission capability.

In specific implementation, before the target model is trained, the method further includes: Preprocess data, which specifically includes:

S2.7: Set different average channel SNRs by changing the noise variance σ² to obtain the plurality of average channel SNRs.

Obtain N classes of image data (for example, aircraft images, automobile images, bird images, cat images, ship images, and truck images) through an N-way K-shot method. A sample in the image data is the original input image. Each class of image data contains K labeled samples. q samples are extracted from each class of image data as prediction samples.

A data set composed of labeled samples is defined as a support set Dₛᵤₚ. A data set composed of prediction samples is defined as a query set D_{Que}.

The support set Dₛᵤₚ and the query set D_{Que} are as follows:

$${D}_{sup} = {( {x}_{i} , {y}_{i} )}_{i = 1}^{N \times K}$$

$${D}_{Que} = {( {x}_{i} , {y}_{i} )}_{i = 1}^{N \times q}$$

xᵢ and yᵢ respectively represent the i^{th} sample in the labeled samples and its corresponding label class. N represents a quantity of classes. K represents a quantity of samples of each class in the support set. q represents a quantity of prediction samples of each class in the query set.

In addition, in specific implementation, image enhancement and other processing may further be performed on the image data in the data set. More details are not described herein.

In this embodiment, the plurality of meta-learning tasks are established based on the plurality of average channel SNRs and a data set including the support set and the query set.

In this embodiment, selections of the neural network model include a convolutional neural network (CNN), a recurrent neural network (RNN), a transformer model, and a long short-term memory (LSTM) network. For example, the neural network model in this embodiment is a CNN.

In this embodiment, end-to-end training is performed on the neural network model, to train and optimize the neural network model such that the obtained target model has an excellent generalization capability and can quickly adapt to a new task even with few samples. The plurality of meta-learning tasks are traversed such that the target model can further have high adaptability to limited samples, to enhance performance of the target model under unknown channel conditions. In this embodiment, specific steps of fine-tuning the target model includes:

S2.9: Obtain a plurality of pieces of few-shot image data as the fine-tuning data set, and divide the data set into a training set, a validation set, and a test set.

The training set is used to fine-tune the model. The validation set is used to adjust model parameters and select appropriate hyperparameters for the model. The test set is used to finally evaluate model performance.

S2.10: Fine-tune an iteratively updated target model through the training set to obtain a fine-tuned target model, namely a meta-learning-based JSCC model.

The fine-tuning includes at least one of learning rate adjustment, algorithm optimization, and regularization. For example, the model parameters are fine-tuned by calculating a loss function and performing backpropagation optimization, or through an optimization algorithm such as gradient descent. An objective of the fine-tuning is to enable the target model to better suit a task requirement of a dynamic channel environment by performing optimization through few-shot tasks.

S2.11: Perform performance validation and evaluation tests on the fine-tuned target model through the validation set and the test set.

Specifically, in an experimental evaluation phase, there is a need to select appropriate evaluation indexes and conduct experiments to evaluate performance of a meta-learning-based pre-training method for few-shot wireless image transmission tasks in a dynamic environment. A PSNR is selected as a transmission quality index to evaluate the model's transmission performance and signal restoration capability. A structural similarity index measure (SSIM), an MSE, and the like are selected as image quality indexes to evaluate, in combination with the validation set and the test set, quality of an image generated by the model.

Performance differences between the meta-learning-based method in this solution, a transfer learning-based method, and a benchmark JSCC model are compared, and an effect of the pre-training method on few-shot wireless image transmission tasks in a dynamic environment is analyzed. In addition, comparative experiments are conducted to compare the meta-learning-based pre-training method with a conventional method or a benchmark model in scenarios of different training samples. The performance difference between the meta-learning-based method and the transfer learning-based method are evaluated by comparing their performance indexes such as a transmission quality index and an image quality index on the test set. Experimental results are analyzed to discuss effects and advantages of the meta-learning-based method and the transfer learning-based method for few-shot wireless image transmission tasks in a dynamic environment.

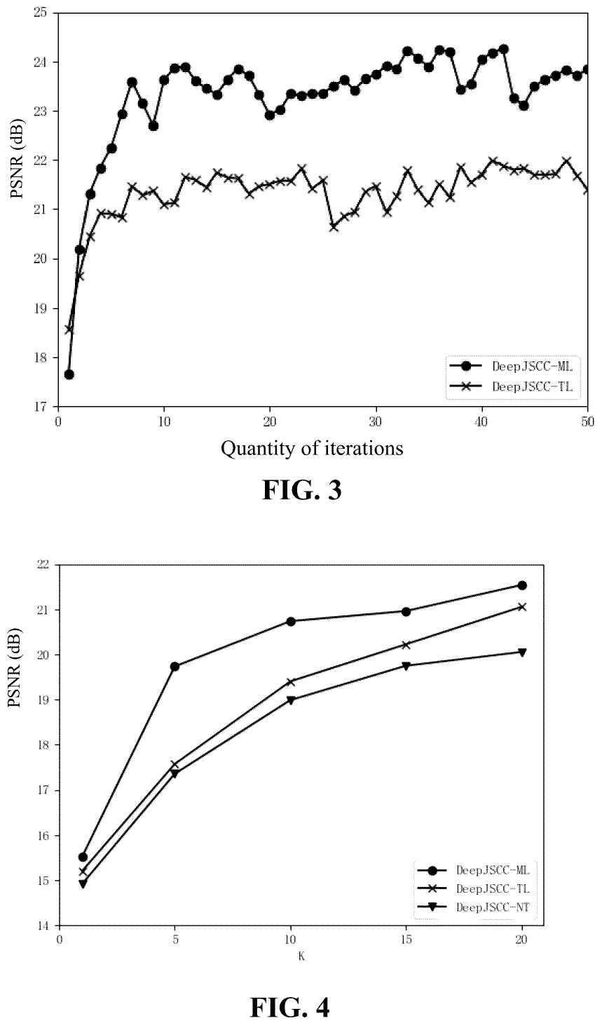

To apply this embodiment of the present disclosure, refer to FIG. 3. FIG. 3 is a diagram of algorithm convergence, showing a convergence curve (DeepJSCC-ML) of the meta-learning-based method in this solution in the fine-tuning phase in a channel environment with a 10-way 20-shot setting and a channel SNR of 10 dB, in comparison with a convergence curve (DeepJSCC-TL) of the transfer learning-based method in the fine-tuning phase. It can be learned that the meta-learning-based method has a better effect, and the model's performance and generalization capability are stronger, enabling fast adaptation and generalization on new tasks.

To apply this embodiment of the present disclosure, refer to FIG. 4. FIG. 4 is a comparison diagram of impact of a quantity of training samples on image transmission performance, showing that PSNRs obtained by different schemes increase as K increases for a 10-way K-shot setting and at a channel SNR of 0 dB. Image transmission performance of the meta-learning-based method (DeepJSCC-ML) is better than that of the transfer learning-based method (DeepJSCC-TL) and a benchmark method (DeepJSCC-NT). At a low SNR in a few-shot scenario, data is extremely limited, and it may be difficult for a conventional training method to obtain sufficient training samples. By contrast, in the meta-learning-based method, training can be performed with few samples of source-channel conditions, to learn knowledge and experience to adapt to channel environments with different SNRs. A fast adaptation capability makes the meta-learning-based method more advantageous at a low SNR in a few-shot scenario.

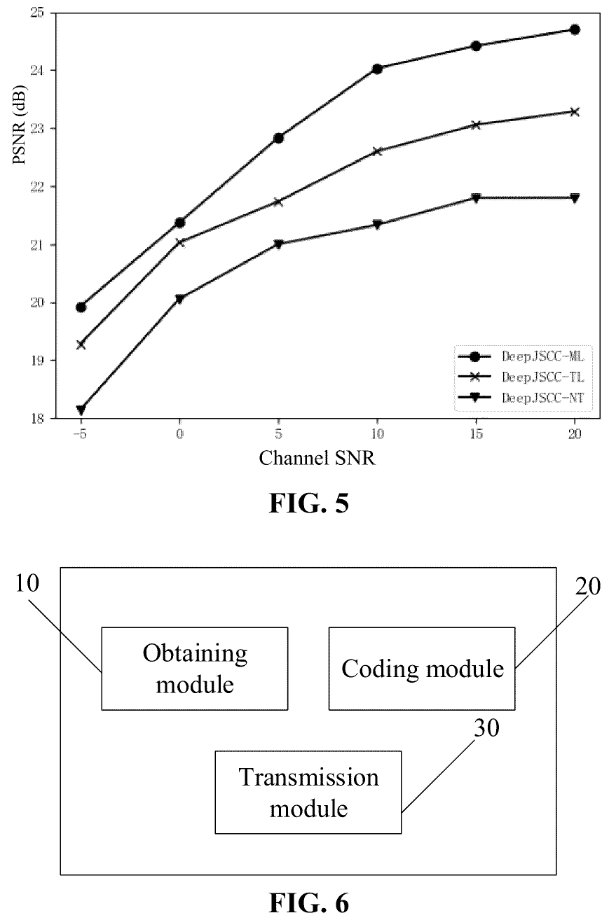

To apply this embodiment of the present disclosure, refer to FIG. 5. FIG. 5 is a diagram of a relationship between a channel environment and image transmission performance, showing image transmission performance of different schemes in different channel environments for a 10-way 20-shot setting. Apparently, the meta-learning-based method (DeepJSCC-ML) in this solution is superior to the transfer learning-based method (DeepJSCC-TL) and a no-transfer method (DeepJSCC-NT). The meta-learning-based JSCC model learns under a plurality of source-channel conditions, to obtain source-channel encoding and decoding strategies and rapidly adapt to a new channel environment. The meta-learning-based JSCC model can adjust the encoding and decoding strategies based on channel conditions to improve transmission efficiency and reliability in channel environments with different SNRs.

For S2.11 in this embodiment, in general, in a dynamic communication scenario, a conventional deep learning method usually can only obtain limited few-shot data due to difficulty in and high costs of obtaining data, and may have a problem of overfitting or an insufficient generalization capability. The meta-learning-based method learns from a plurality of few-shot tasks in a large-scale data set in the pre-training phase such that the model has priori knowledge and a generalization capability, and can quickly adapt to new few-shot tasks, to perform better in a few-shot scenario during communication in a dynamic environment.

The meta-learning-based method can obtain specific knowledge and experience in advance from the large-scale data set by pre-training the model. The priori knowledge includes information such as channel conditions, noise conditions, and transmission parameters. When faced with few-shot tasks in a dynamic environment, the model can make use of the priori knowledge to better understand and process a current image transmission task and improve transmission performance. Compared with a method for performing training from scratch, the meta-learning-based method can utilize the priori knowledge more efficiently, to achieve a better effect in the dynamic environment.

Due to complexity and uncertainty of a dynamic communication environment, transmission quality is affected by a plurality of factors, such as water quality, a propagation loss, and multipath fading. In the face of a new communication task, the conventional method may not adapt well to these changes. Through pre-training and fine-tuning, the meta-learning-based method enables the model to have a strong generalization capability and quickly adapt to different communication environments and task requirements, to improve transmission performance and stability.

S3: Transmit the target image based on the coding result.

In this embodiment of the present disclosure, S3 is specifically as follows:

Transmit the target image based on the coding result.

Overall, this embodiment of the present disclosure has the following beneficial effects:

This embodiment aims to train the neural network model to adapt to few-shot image transmission tasks under different channel conditions through the meta-learning-based method and by designing a relationship between a class of the support set and a quantity of samples. The communication channel is incorporated into the neural network architecture as untrainable layers such that accuracy of a communication channel model can be improved. This helps better capture the dynamic characteristics of the channel, improves reliability of a communication system in a complex or unstable communication environment, and further reduces overfitting of the neural network model to specific channel conditions to improve performance robustness under various channel conditions.

In addition, an internal network parameter and a meta-parameter of the deep JSCC model can be optimized and updated during training such that the deep JSCC model fully learns connections and differences between information through limited training tasks, and has good image coding and transmission capabilities and adaptability. In this way, end-to-end training is performed on the neural network model based on the plurality of meta-learning tasks such that the obtained target model can rapidly adapt to different channel environments, and the image coding and transmission capabilities are further improved through the plurality of meta-learning tasks.

### Embodiment 2

Referring to FIG. 6, an embodiment of the present disclosure provides a meta-learning-based JSCC apparatus, including an obtaining module 10, a coding module 20, and a transmission module 30.

The obtaining module 10 is configured to obtain a target image.

The coding module 20 is configured to perform JSCC on the target image through a preset target model to obtain a coding result. The target model is obtained by performing inner-loop and outer-loop training on a preset neural network model based on a plurality of meta-learning tasks. The plurality of meta-learning tasks are constructed based on a plurality of average channel SNRs.

The transmission module 30 is configured to transmit the target image based on the coding result.

In an embodiment, the obtaining module 10 is specifically configured to:
obtain the target image, where the target image is an image to be wirelessly transmitted.

In an embodiment, the coding module 20 is specifically configured to:
perform JSCC on the target image through the preset target model to obtain the coding result.

A structure for constructing the target model includes a task construction unit (including a first construction subunit, a second construction subunit, and a third construction subunit), an inner updating unit, an outer updating unit (including a first updating subunit and a second updating subunit), a model training unit (including a first training subunit, a second training subunit, a third training subunit, a fourth training subunit, and a fifth training subunit), a model obtaining unit, a fine-tuning unit, a first establishment unit, a second establishment unit, a third establishment unit, a division unit, an optimization unit, and a test unit.

Referring to FIG. 11, the coding module includes the task construction unit. The task construction unit includes the first construction subunit, the second construction subunit, and the third construction subunit.

The first construction subunit is configured to establish a joint transfer function through a preset channel fading transfer function and Gaussian channel transfer function.

The second construction subunit is configured to determine the plurality of average channel SNRs based on an average power of a channel input signal and a plurality of preset noise variances. Specifically, the average channel SNRs are obtained by changing a noise variance σ² such that the average channel SNRs are 0 dB, 5 dB, 10 dB, 15 dB, and 20 dB.

The third construction subunit is configured to establish the plurality of meta-learning tasks based on the joint transfer function and the plurality of average channel SNRs. The plurality of average channel SNRs are in a one-to-one correspondence with the plurality of meta-learning tasks.

The joint transfer function is as follows:

$$η ( z ) = {η}_{n} ( {η}_{h} ( z ) ) = hz + n$$

A multiplicative effect of a channel gain on a transmitted signal is captured by a channel fading transfer function ηₕ(z)=hz (namely a Rayleigh fading model). h˜ [symbol] (0, H_{c}) is a complex normal random variable. h represents the channel gain. z represents the transmitted signal. n represents Gaussian noise. H_{c} is a covariance matrix of the channel gain h, which contains power and correlation information of all dimensions of a channel, and is a key parameter of a channel statistical model. The Gaussian channel transfer function is ηₙ(z)=z+n. n˜ [symbol] (0,σ²I_{b}) represents noise. σ² represents a noise power or noise variance, namely average energy of each noise component, reflecting a noise intensity. I_{b} is a b-dimensional identity matrix, representing isotropic white noise.

The average channel SNR is calculated through the following formula:

$$SNR = 10 {log}_{10} \frac{P}{{σ}^{2}}$$

P represents the average power of the channel input signal after a power normalization layer is applied to an encoder. P=1. SNR is expressed in decibels (dB).

A channel in each training task constructed in this embodiment is a Rayleigh slow fading model. Because the Rayleigh fading model is suitable for describing a wireless channel in a central area of a town with dense buildings, the plurality of meta-learning tasks (namely training tasks) can be rapidly constructed based on the channel fading transfer function and Gaussian channel transfer function in combination with the average channel SNRs. This task construction method is simple and fast. In addition, the constructed meta-learning tasks encompass different channel conditions. This can facilitate adaptive training of the model, to improve a generalization capability of the model.

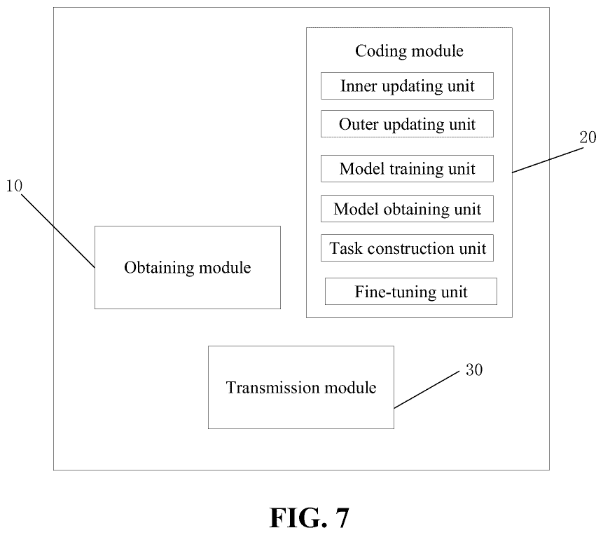

Referring to FIG. 7, the coding module includes the inner updating unit, the outer updating unit, the model training unit, and the model obtaining unit.

The inner updating unit is configured to update an internal network parameter of the preset neural network model through an inner loop, that is, initialize the internal network parameter θ of the preset model through a meta-parameter ϕ at the beginning of each inner loop, and optimize and update an initialized internal network parameter based on a preset first loss function through a preset support set by using an Adam optimizer, to obtain a first trained model.

The first loss function is as follows:

$$ℒ = \frac{1}{N} {\sum }_{i = 1}^{N} d ( {x}_{i} , {\hat{x}}_{i} )$$

$$d ( {x}_{i} , {\hat{x}}_{i} ) = \frac{1}{n} {‖ {x}_{i} - {\hat{x}}_{i} ‖}^{2}$$

represents an MSE distortion. xᵢ is a sample i in the support set. \hat{x}ᵢ is an estimate of the sample i. N is a quantity of samples. n is a quantity of pixels in xᵢ.

A specific process of optimizing and updating the initialized internal network parameter is as follows: For an internal network parameter θⱼ of the j^{th} meta-learning task in the plurality of meta-learning tasks in the inner loop, calculate a gradient through the first loss function [symbol] , and update the internal network parameter θⱼ based on an average value of the calculated gradient and a historical gradient for the internal network parameter through a gradient descent method by using the Adam optimizer.

The foregoing process of updating the internal network parameter θⱼ may be expressed as follows:

$${θ}_{j} ← {θ}_{j} - β {∇}_{{θ}_{j}} {ℒ}_{{D}_{sup} ( j )} ( {θ}_{j} )$$

∇₇₄ _{ⱼ} [symbol] _{D}_{ₛᵤₚ}₍ⱼ₎(θⱼ) represents a gradient of a loss function [symbol] _{D}_{ₛᵤₚ}₍ⱼ₎(θⱼ) for the parameter θ in the inner loop. D_{Sup}(j) is a support set of the j^{th} task. β is a learning rate of the inner loop. θⱼ is the internal network parameter of the j^{th} task.

It should be noted that the preset neural network model is a neural network model constructed based on the meta-parameter ϕ and the internal network parameter θ.

The meta-parameter ϕ is a global parameter in an entire meta-learning process and is optimized in an outer loop of meta-learning. The meta-parameter ϕ is responsible for learning common data information from the plurality of meta-learning tasks, enabling rapid adaptation to a new task or environment. The meta-parameter ϕ is specifically a parameter of a convolutional layer, batch normalization layer, and fully connected layer in the network model.

The internal network parameter θ is specific to a single training task and is optimized in an inner loop of meta-learning. In each specific task (image transmission task at a specific channel SNR), the internal network parameter θ is rapidly adjusted to suit a requirement of the task. The internal network parameter θ is derived from the meta-parameter ϕ and optimized for the specific task.

In this embodiment, initializing the internal network parameter of the neural network model enables the neural network model to better generalize to a new task and concept. In addition, parameters of the inner loop are optimized and updated by observing data of the support set. These parameters pay more attention to details of specific tasks. This can help the neural network model learn more connections and differences between information in the training tasks, to enhance adaptability of the model.

The outer updating unit is configured to optimize and update a meta-parameter of the first trained model based on a preset meta-loss function through a preset query set to obtain a second trained model. Referring to FIG. 9, the outer updating unit includes the first updating subunit and the second updating subunit.

The first updating subunit is configured to update the meta-parameter through an outer loop, that is, establish a meta-loss function through a loss function of the meta-parameter ϕ of the first trained model on the query set after performing a first training task.

The second updating subunit is configured to optimize and update the meta-parameter of the first trained model with an objective of minimizing the meta-loss function, to obtain the second trained model.

Minimizing the meta-loss function is as follows:

$${min}_{ϕ} {ℒ}_{meta} ( ϕ ) = {\sum }_{j ∈ ℋ} {ℒ}_{{D}_{Que} ( j )} ( {θ}_{j} )$$

[symbol] ₘₑₜₐ is a loss function associated with a parameter (namely the internal network parameter) θ specific to a meta-learning task on the query set. θⱼ is an optimized internal network parameter obtained after performing the j^{th} meta-learning task. [symbol] _{D}_{_{Que}}₍ⱼ₎ is the loss function of the optimized parameter θⱼ obtained after performing the j^{th} meta-learning task on the query set. j is an ordinal number of the meta-learning task. [symbol] is a total quantity of meta-learning tasks.

In this embodiment, performance of the first trained model is optimized through the query set. Because the query set usually contains a plurality of tasks or concepts and encompasses a wide range of data information, calculating the meta-loss function on the query set and updating the parameter of the first trained model through the meta-loss function can reduce a loss of the obtained second trained model on the entire query set such that the second trained model has a good generalization capability.

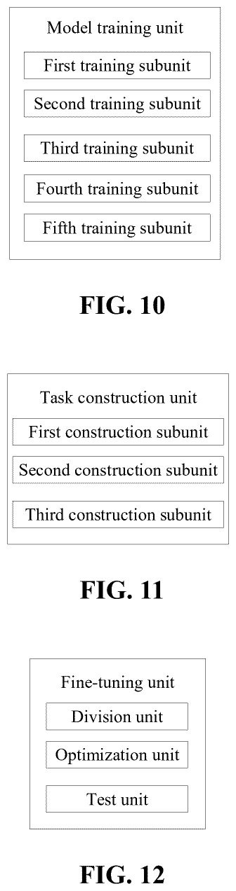

The model training unit is configured to train the second trained model through one of the plurality of meta-learning tasks to obtain a third trained model. The plurality of meta-learning tasks are constructed based on a Rayleigh slow fading model and preset channel SNRs. Referring to FIG. 10, the model training unit includes the first training subunit, the second training subunit, the third training subunit, the fourth training subunit, and the fifth training subunit.

The first training subunit is configured to map a preset original input image x (x∈R^{m}) onto a complex-valued channel input symbol (namely the transmitted signal) z (z∈C^{k}) of the one of the plurality of meta-learning tasks to obtain an output signal z′. A size of the original input image x is H (height)×W (width)×C (quantity of channels). m=H×W×C. R represents a real number set. C represents a complex number set. k represents a size of a channel input symbol (namely the complex-valued channel input symbol z).

The second training subunit is configured to perform JSCC on the original input image through the second trained model to obtain a first coding result.

The third training subunit is configured to transmit the output signal z′ on a channel based on the first coding result to obtain corrupted output data.

The fourth training subunit is configured to perform approximate reconstruction of the original input image based on the corrupted output data to obtain a reconstructed image \hat{x} (\hat{x}∈R^{m}).

The fifth training subunit is configured to modify the second trained model based on the original input image and the reconstructed image to obtain the third trained model.

In specific implementation, the original input image x may be obtained from, for example, a CIFAR-10 image data set. Certainly, it may alternatively be obtained from another image data set. More details are not described herein.

To apply this embodiment of the present disclosure, refer to FIG. 2. FIG. 2 is a system architecture diagram of a meta-learning-based deep JSCC scheme, providing a specific process of reconstructing an image. A changing transmission channel environment is simulated by establishing a wireless image transmission system in a plurality of channel environments and setting channel SNRs. The wireless image transmission system is designed through a JSCC technology. Specifically, an encoder combined with the second trained model is deployed at a transmit end, and is responsible for performing source coding and channel coding on the original input image x, converting image data into coded data suitable for transmission, and performing compression coding on the image. A wireless communication channel is modeled as a series of untrainable layers incorporated into an entire neural network architecture. A decoder is disposed at a receive end to invert the encoder's operations through a series of transposed convolutional layers (the transposed convolutional layers are followed by a non-linear activation function) to restore the image and obtain the reconstructed image.

In this embodiment, the third trained model is obtained by performing training and optimization through actual training tasks. The original input image x is mapped onto the complex-valued channel input symbol z, and then the output signal z′ is transmitted on the channel. In this way, an amplitude and frequency distribution of an image signal can be controlled within a proper range, to reduce required bandwidth and improve transmission efficiency in terms of SNRs. In addition, because the complex-valued channel input symbol z can counteract impact of channel noise through phase adjustment, transmission reliability can be improved.

The output signal is transmitted on the channel in combination with the first coding result of the second trained model, and actual corrupted data may be obtained. Approximate reconstruction is performed based on the data. The obtained reconstructed image can reflect a difference between itself and the original input image such that the second trained model can be modified by using the two images as control groups, to optimize a coding capability of the third trained model.

In addition, performing training through an actual channel helps the model better capture dynamic characteristics of the channel, improves reliability of a communication system in a complex or unstable communication environment, and can reduce overfitting of the neural network model to specific channel conditions to improve robustness of the third trained model under various channel conditions.

The model obtaining unit is configured to iteratively update an internal network parameter and a meta-parameter of the third trained model, and traverse the other meta-learning tasks in the plurality of meta-learning tasks through an optimized and updated third trained model until the meta-loss function [symbol] ₘₑₜₐ converges, to obtain a preliminary target model.

The coding module further includes the fine-tuning unit. The fine-tuning unit is configured to fine-tune the target model through a preset fine-tuning data set.

The fine-tuning includes at least one of learning rate adjustment, algorithm optimization, and regularization.

In this embodiment, the fine-tuning unit is specifically configured to:
initialize an internal network parameter of the target model based on a meta-parameter of the target model obtained after the training through the plurality of meta-learning tasks; and
iteratively update the internal network parameter of the target model through the fine-tuning data set and a gradient descent algorithm.

Specifically, the fine-tuning unit is configured to initialize an internal network parameter θₖ in a preset channel environment with a specific target channel SNR through the meta-parameter ϕ obtained after meta-learning. The parameter θₖ is a model parameter corresponding to image transmission for the target model in a new target environment.

The fine-tuning unit is further configured to adaptively fine-tune θₖ again on the fine-tuning data set (namely a preset adaptive data set D_{Ad}(k)) through the gradient descent method, to obtain a further improved target model, which is also referred to as a deep JSCC model.

The foregoing process of fine-tuning and optimizing the parameter θₖ may be expressed as follows:

$${θ}_{k} ← {θ}_{k} - γ {∇}_{{θ}_{k}} {ℒ}_{{D}_{Ad} ( k )} ( {θ}_{k} )$$

γ represents a learning rate of the target model in a target environment. [symbol] _{Ad(k)}(θₖ) represents a loss function on D_{Ad}(k). ∇₇₄ _{ⱼ} [symbol] _{D}_{ₛᵤₚ}₍ₖ₎(θₖ) represents a gradient of the loss function [symbol] _{Ad(k)}(θₖ) for the parameter θₖ.

In specific implementation, the adaptive data set D_{Ad}(k) may be obtained from, for example, a CIFAR-10 image data set. Certainly, it may alternatively be obtained from another image data set. More details are not described herein. In addition, in actual application, training of the internal network parameter requires only the internal network parameter to be iteratively updated. Parameter updating of an inner network needs to be fed back to an outer network, and then the meta-parameter is iteratively updated, to obtain a better network initialization parameter.

It should be noted that performance of the foregoing deep JSCC algorithm and all benchmark schemes is quantized based on a peak SNR (PSNR). A PSNR index measures a ratio between a maximum possible power of a signal and a noise power of an interference signal, expressed as follows:

$$PSNR = 10 {log}_{10} \frac{{MAX}^{2}}{MSE}$$

MSE=d(x,\hat{x}) is an MSE between the original input image x and the reconstructed image \hat{x}. MAX is a maximum possible value of an image pixel. MAX=2⁸−1=255 for an RGB image.

In this embodiment, in general, initializing the parameters of the inner loop through parameters of the outer loop enables the model to better generalize to a new task or concept. The parameters of the outer loop are adjusted on a larger query set through a global optimization algorithm. These parameters include the generalization capability of the model on various tasks. The parameters of the inner loop are updated by observing the data of the support set. These parameters pay more attention to the details of specific tasks. Updating the internal network parameter and the meta-parameter of the neural network model through alternate training can continuously optimize the model and improve adaptability to new tasks with few samples. In this way, the finally obtained deep JSCC model has good image coding and transmission capabilities and adaptability, and can be used for subsequent training of the neural network model, such that the neural network model quickly adapts to different channel environments.

In addition, at the end of a pre-training phase, the meta-parameter of a pre-trained target model is stored for subsequent fine-tuning and testing. Through a final fine-tuning phase, the target model can perform parameter updating in the new target environment to have a more reliable image transmission capability.

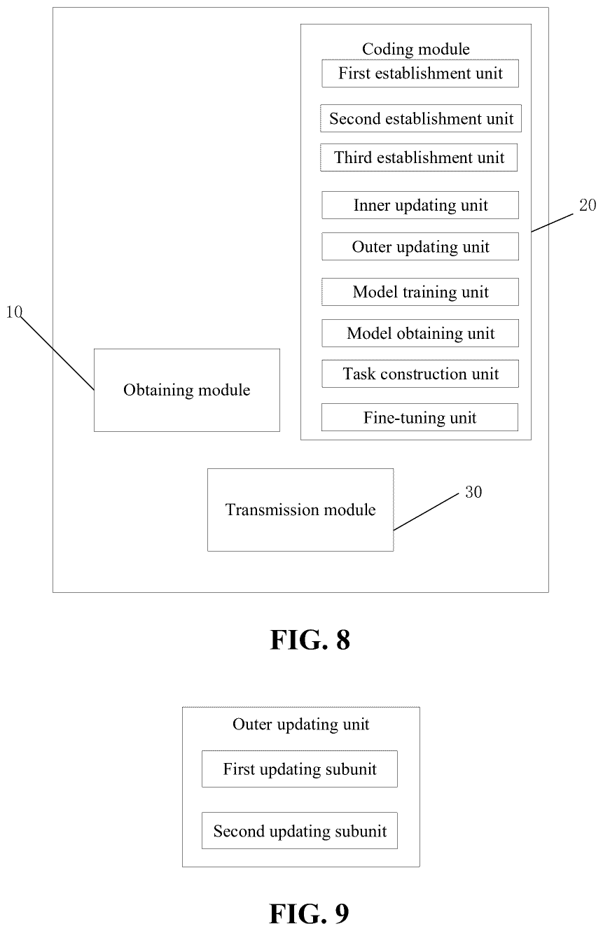

Referring to FIG. 8, in this embodiment, the coding module further includes the first establishment unit, the second establishment unit, and the third establishment unit.

The first establishment unit is configured to set different average channel SNRs by changing the noise variance σ² to obtain the plurality of average channel SNRs.

The second establishment unit is configured to obtain N classes of image data (for example, aircraft images, automobile images, bird images, cat images, ship images, and truck images) through an N-way K-shot method. A sample in the image data is the original input image. Each class of image data contains K labeled samples. q samples are extracted from each class of image data as prediction samples.

The second establishment unit is further configured to define a data set composed of labeled samples as a support set Dₛᵤₚ and a data set composed of prediction samples as a query set D_{Que}.

The support set Dₛᵤₚ and the query set D_{Que} are as follows:

$${D}_{sup} = {( {x}_{i} , {y}_{i} )}_{i = 1}^{N \times K}$$

$${D}_{Que} = {( {x}_{i} , {y}_{i} )}_{i = 1}^{N \times q}$$

xᵢ and yᵢ respectively represent the i^{th} sample in the labeled samples and its corresponding label class. N represents a quantity of classes. K represents a quantity of samples of each class in the support set. q represents a quantity of prediction samples of each class in the query set.

The third establishment unit is configured to establish the plurality of meta-learning tasks based on the plurality of average channel SNRs and a data set including the support set and the query set.

In this embodiment, selections of the neural network model include a CNN, an RNN, a transformer model, and an LSTM network. For example, the neural network model in this embodiment is a CNN.

In this embodiment, end-to-end training is performed on the neural network model, to train and optimize the neural network model such that the obtained target model has an excellent generalization capability and can quickly adapt to a new task even with few samples. The plurality of meta-learning tasks are traversed such that the target model can further have high adaptability to limited samples, to enhance performance of the target model under unknown channel conditions.

Referring to FIG. 12, for example, the fine-tuning unit specifically includes the division unit, the optimization unit, and the test unit.

The division unit is configured to obtain a plurality of pieces of few-shot image data as the fine-tuning data set, and divide the data set into a training set, a validation set, and a test set.

The training set is used to fine-tune the model. The validation set is used to adjust model parameters and select appropriate hyperparameters for the model. The test set is used to finally evaluate model performance.

The optimization unit is configured to fine-tune an iteratively updated target model through the training set to obtain a fine-tuned target model, namely a meta-learning-based JSCC model.

The fine-tuning includes at least one of learning rate adjustment, algorithm optimization, and regularization. For example, the model parameters are fine-tuned by calculating a loss function and performing backpropagation optimization, or through an optimization algorithm such as gradient descent. An objective of the fine-tuning is to enable the target model to better suit a task requirement of a dynamic channel environment by performing optimization through few-shot tasks.

The test unit is configured to perform performance validation and evaluation tests on the fine-tuned target model through the validation set and the test set.

Specifically, in an experimental evaluation phase, there is a need to select appropriate evaluation indexes and conduct experiments to evaluate performance of a meta-learning-based pre-training method for few-shot wireless image transmission tasks in a dynamic environment. A PSNR is selected as a transmission quality index to evaluate the model's transmission performance and signal restoration capability. An SSIM, an MSE, and the like are selected as image quality indexes to evaluate, in combination with the validation set and the test set, quality of an image generated by the model.

Performance differences between the meta-learning-based method in this solution, a transfer learning-based method, and a benchmark JSCC model are compared, and an effect of the pre-training method on few-shot wireless image transmission tasks in a dynamic environment is analyzed. In addition, comparative experiments are conducted to compare the meta-learning-based pre-training method with a conventional method or a benchmark model in scenarios of different training samples. The performance difference between the meta-learning-based method and the transfer learning-based method are evaluated by comparing their performance indexes such as a transmission quality index and an image quality index on the test set. Experimental results are analyzed to discuss effects and advantages of the meta-learning-based method and the transfer learning-based method for few-shot wireless image transmission tasks in a dynamic environment.

To apply this embodiment of the present disclosure, refer to FIG. 3. FIG. 3 is a diagram of algorithm convergence, showing a convergence curve (DeepJSCC-ML) of the meta-learning-based method in this solution in the fine-tuning phase in a channel environment with a 10-way 20-shot setting and a channel SNR of 10 dB, in comparison with a convergence curve (DeepJSCC-TL) of the transfer learning-based method in the fine-tuning phase. It can be learned that the meta-learning-based method has a better effect, and the model's performance and generalization capability are stronger, enabling fast adaptation and generalization on new tasks.

To apply this embodiment of the present disclosure, refer to FIG. 4. FIG. 4 is a comparison diagram of impact of a quantity of training samples on image transmission performance, showing that PSNRs obtained by different schemes increase as K increases for a 10-way K-shot setting and at a channel SNR of 0 dB. Image transmission performance of the meta-learning-based method (DeepJSCC-ML) is better than that of the transfer learning-based method (DeepJSCC-TL) and a benchmark method (DeepJSCC-NT). At a low SNR in a few-shot scenario, data is extremely limited, and it may be difficult for a conventional training method to obtain sufficient training samples. By contrast, in the meta-learning-based method, training can be performed with few samples of source-channel conditions, to learn knowledge and experience to adapt to channel environments with different SNRs. A fast adaptation capability makes the meta-learning-based method more advantageous at a low SNR in a few-shot scenario.

To apply this embodiment of the present disclosure, refer to FIG. 5. FIG. 5 is a diagram of a relationship between a channel environment and image transmission performance, showing image transmission performance of different schemes in different channel environments for a 10-way 20-shot setting. Apparently, the meta-learning-based method (DeepJSCC-ML) in this solution is superior to benchmark schemes including the transfer learning-based method (DeepJSCC-TL) and a no-transfer method (DeepJSCC-NT). The meta-learning-based JSCC model learns under a plurality of source-channel conditions, to obtain source-channel encoding and decoding strategies and rapidly adapt to a new channel environment. The meta-learning-based JSCC model can adjust the encoding and decoding strategies based on channel conditions to improve transmission efficiency and reliability in channel environments with different SNRs.

For the test unit in this embodiment, in general, in a dynamic communication scenario, a conventional deep learning method usually can only obtain limited few-shot data due to difficulty in and high costs of obtaining data, and may have a problem of overfitting or an insufficient generalization capability. The meta-learning-based method learns from a plurality of few-shot tasks in a large-scale data set in the pre-training phase such that the model has priori knowledge and a generalization capability, and can quickly adapt to new few-shot tasks, to perform better in a few-shot scenario during communication in a dynamic environment.

The meta-learning-based method can obtain specific knowledge and experience in advance from the large-scale data set by pre-training the model. The priori knowledge includes information such as channel conditions, noise conditions, and transmission parameters. When faced with few-shot tasks in a dynamic environment, the model can make use of the priori knowledge to better understand and process a current image transmission task and improve transmission performance. Compared with a method for performing training from scratch, the meta-learning-based method can utilize the priori knowledge more efficiently, to achieve a better effect in the dynamic environment.

Due to complexity and uncertainty of a dynamic communication environment, transmission quality is affected by a plurality of factors, such as water quality, a propagation loss, and multipath fading. In the face of a new communication task, the conventional method may not adapt well to these changes. Through pre-training and fine-tuning, the meta-learning-based method enables the model to have a strong generalization capability and quickly adapt to different communication environments and task requirements, to improve transmission performance and stability.

In an embodiment, the transmission module 30 is specifically configured to:
transmit the target image based on the coding result.

Overall, this embodiment of the present disclosure has the following beneficial effects:

The apparatus aims to train a model network to adapt to few-shot image transmission tasks under different channel conditions through the meta-learning-based method and by designing a relationship between a class of the support set and a quantity of samples. The communication channel is incorporated into the neural network architecture as untrainable layers such that accuracy of a communication channel model can be improved. This helps better capture the dynamic characteristics of the channel, improves reliability of a communication system in a complex or unstable communication environment, and further reduces overfitting of the model network to specific channel conditions to improve performance robustness under various channel conditions.

In addition, an internal network parameter and a meta-parameter of the deep JSCC model can be optimized and updated during training such that the deep JSCC model fully learns connections and differences between information through limited training tasks, and has good image coding and transmission capabilities and adaptability. In this way, end-to-end training is performed on the neural network model based on the plurality of meta-learning tasks such that the obtained target model learns the deep JSCC model's capability of rapidly adapting to different channel environments, and the image coding and transmission capabilities are further improved through the plurality of meta-learning tasks.

In this embodiment of the present application, the meta-learning-based JSCC apparatus includes a processor and a memory. The processor is configured to execute the following program modules and program units stored in the memory: the obtaining module 10, the coding module 20, the transmission module 30, the first construction subunit, the second construction subunit, the third construction subunit, the inner updating unit, the first updating subunit, the second updating subunit, the first training subunit, the second training subunit, the third training subunit, the fourth training subunit, the fifth training subunit, the model obtaining unit, the fine-tuning unit, the first establishment unit, the second establishment unit, the third establishment unit, the division unit, the optimization unit, and the test unit.

### Embodiment 3

An embodiment of the present disclosure provides a non-transitory computer-readable storage medium. The non-transitory computer-readable storage medium includes a stored computer program. When the computer program is run, a device in which the non-transitory computer-readable storage medium is located is controlled to perform the meta-learning-based JSCC method.

If implemented in a form of a software functional unit and used as a standalone product, the meta-learning-based JSCC method may be stored in a non-transitory computer-readable storage medium. Based on such an understanding, all or some of processes for implementing the method in the foregoing embodiments of the present disclosure may be completed by a computer program instructing relevant hardware. The computer program may be stored in a non-transitory computer-readable storage medium. When the computer program is executed by the processor, the steps in the foregoing method embodiments may be implemented. The computer program includes computer program code. The computer program code may be in a form of source code, in a form of object code, an executable file, in some intermediate forms, or the like. The non-transitory computer-readable medium may include any physical entity or apparatus capable of carrying the computer program code, a recording medium, a universal serial bus (USB) disk, a removable hard disk, a magnetic disk, an optical disc, a computer memory, a read-only memory (ROM), a random access memory (RAM), a software distribution medium, or the like.

The foregoing descriptions are merely preferred implementations of the present disclosure. It should be noted that several improvements and modifications may further be made by a person of ordinary skill in the art without departing from the principle of the present disclosure, and such improvements and modifications should also be deemed as falling within the protection scope of the present disclosure.

1. A meta-learning-based joint source-channel coding (JSCC) method, comprising:
obtaining a target image;
performing JSCC on the target image through a preset target model to obtain a coding result, wherein the target model is obtained by performing inner-loop and outer-loop training on a preset neural network model based on a plurality of meta-learning tasks, and the plurality of meta-learning tasks are constructed based on a plurality of average channel signal-to-noise ratios (SNRs); and
transmitting the target image based on the coding result.

2. The meta-learning-based JSCC method according to claim 1, wherein constructing the target model comprises:
initializing an internal network parameter of the neural network model, and optimizing and updating an initialized internal network parameter based on a preset first loss function through a preset support set to obtain a first trained model;
optimizing and updating a meta-parameter of the first trained model based on a preset meta-loss function through a preset query set to obtain a second trained model;
training the second trained model through one of the plurality of meta-learning tasks to obtain a third trained model; and
iteratively updating an internal network parameter and a meta-parameter of the third trained model, and traversing the other meta-learning tasks in the plurality of meta-learning tasks through an optimized and updated third trained model to obtain the target model.

3. The meta-learning-based JSCC method according to claim 2, wherein the optimizing and updating a meta-parameter of the first trained model based on a preset meta-loss function through a preset query set to obtain a second trained model specifically comprises:
establishing the meta-loss function through a loss function of the meta-parameter of the first trained model on the query set; and
optimizing and updating the meta-parameter of the first trained model with an objective of minimizing the meta-loss function, to obtain the second trained model.

4. The meta-learning-based JSCC method according to claim 2, wherein the training the second trained model through one of the plurality of meta-learning tasks to obtain a third trained model specifically comprises:
mapping a preset original input image onto a complex-valued channel input symbol of the one of the plurality of meta-learning tasks to obtain an output signal;
performing JSCC on the original input image through the second trained model to obtain a first coding result;
transmitting the output signal on a channel based on the first coding result to obtain corrupted output data;
performing approximate reconstruction of the original input image based on the corrupted output data to obtain a reconstructed image; and
modifying the second trained model based on the original input image and the reconstructed image to obtain the third trained model.

5. The meta-learning-based JSCC method according to claim 1, wherein constructing the plurality of meta-learning tasks comprises:
establishing a joint transfer function through a preset channel fading transfer function and Gaussian channel transfer function;
determining the plurality of average channel SNRs based on an average power of a channel input signal and a plurality of preset noise variances; and
establishing the plurality of meta-learning tasks based on the joint transfer function and the plurality of average channel SNRs, wherein the plurality of average channel SNRs are in a one-to-one correspondence with the plurality of meta-learning tasks.

6. The meta-learning-based JSCC method according to claim 2, wherein constructing the target model further comprises:
fine-tuning the target model through a preset fine-tuning data set; wherein
the fine-tuning comprises at least one of learning rate adjustment, algorithm optimization, and regularization.

7. The meta-learning-based JSCC method according to claim 6, wherein the fine-tuning the target model through a preset fine-tuning data set specifically comprises:
initializing an internal network parameter of the target model based on a meta-parameter of the target model obtained after the training through the plurality of meta-learning tasks; and
iteratively updating the internal network parameter of the target model through the fine-tuning data set and a gradient descent algorithm.

8. A meta-learning-based joint source-channel coding (JSCC) apparatus, comprising an obtaining module, a coding module, and a transmission module; wherein
the obtaining module is configured to obtain a target image;
the coding module is configured to perform JSCC on the target image through a preset target model to obtain a coding result, wherein the target model is obtained by performing inner-loop and outer-loop training on a preset neural network model based on a plurality of meta-learning tasks, and the plurality of meta-learning tasks are constructed based on a plurality of average channel signal-to-noise ratios (SNRs); and
the transmission module is configured to transmit the target image based on the coding result.

9. The meta-learning-based JSCC apparatus according to claim 8, wherein the coding module comprises an inner updating unit, an outer updating unit, a model training unit, and a model obtaining unit;
the inner updating unit is configured to initialize an internal network parameter of the neural network model, and optimize and update an initialized internal network parameter based on a preset first loss function through a preset support set to obtain a first trained model;
the outer updating unit is configured to optimize and update a meta-parameter of the first trained model based on a preset meta-loss function through a preset query set to obtain a second trained model;
the model training unit is configured to train the second trained model through one of the plurality of meta-learning tasks to obtain a third trained model, wherein the plurality of meta-learning tasks are constructed based on a Rayleigh slow fading model and preset channel SNRs; and
the model obtaining unit is configured to iteratively update an internal network parameter and a meta-parameter of the third trained model, and traverse the other meta-learning tasks in the plurality of meta-learning tasks through an optimized and updated third trained model to obtain the target model.

10. The meta-learning-based JSCC apparatus according to claim 9, wherein the outer updating unit comprises a first updating subunit and a second updating subunit;
the first updating subunit is configured to establish the meta-loss function through a loss function of the meta-parameter of the first trained model on the query set; and
the second updating subunit is configured to optimize and update the meta-parameter of the first trained model with an objective of minimizing the meta-loss function, to obtain the second trained model.

11. The meta-learning-based JSCC apparatus according to claim 9, wherein the model training unit comprises a first training subunit, a second training subunit, a third training subunit, a fourth training subunit, and a fifth training subunit;
the first training subunit is configured to map a preset original input image onto a complex-valued channel input symbol of the one of the plurality of meta-learning tasks to obtain an output signal;
the second training subunit is configured to perform JSCC on the original input image through the second trained model to obtain a first coding result;
the third training subunit is configured to transmit the output signal on a channel based on the first coding result to obtain corrupted output data;
the fourth training subunit is configured to perform approximate reconstruction of the original input image based on the corrupted output data to obtain a reconstructed image; and
the fifth training subunit is configured to modify the second trained model based on the original input image and the reconstructed image to obtain the third trained model.

12. The meta-learning-based JSCC apparatus according to claim 8, wherein the coding module further comprises a task construction unit, and the task construction unit comprises a first construction subunit, a second construction subunit, and a third construction subunit;
the first construction subunit is configured to establish a joint transfer function through a preset channel fading transfer function and Gaussian channel transfer function;
the second construction subunit is configured to determine a plurality of average channel SNRs based on an average power of a channel input signal and a plurality of preset noise variances; and
the third construction subunit is configured to establish the plurality of meta-learning tasks based on the joint transfer function and the plurality of average channel SNRs, wherein the plurality of average channel SNRs are in a one-to-one correspondence with the plurality of meta-learning tasks.

13. The meta-learning-based JSCC apparatus according to claim 9, wherein the coding module further comprises a fine-tuning unit, and the fine-tuning unit is configured to:
fine-tune the target model through a preset fine-tuning data set; wherein
the fine-tuning comprises at least one of learning rate adjustment, algorithm optimization, and regularization.

14. The meta-learning-based JSCC apparatus according to claim 13, wherein the fine-tuning unit is specifically configured to:
initialize an internal network parameter of the target model based on a meta-parameter of the target model obtained after the training through the plurality of meta-learning tasks; and
iteratively update the internal network parameter of the target model through the fine-tuning data set and a gradient descent algorithm.

15. A non-transitory computer-readable storage medium, wherein the non-transitory computer-readable storage medium stores a computer program, and the computer program is invoked and executed by a computer to implement the meta-learning-based joint source-channel coding (JSCC) method according to claim 1.

16. A non-transitory computer-readable storage medium, wherein the non-transitory computer-readable storage medium stores a computer program, and the computer program is invoked and executed by a computer to implement the meta-learning-based joint source-channel coding (JSCC) method according to claim 2.

17. A non-transitory computer-readable storage medium, wherein the non-transitory computer-readable storage medium stores a computer program, and the computer program is invoked and executed by a computer to implement the meta-learning-based joint source-channel coding (JSCC) method according to claim 3.

18. A non-transitory computer-readable storage medium, wherein the non-transitory computer-readable storage medium stores a computer program, and the computer program is invoked and executed by a computer to implement the meta-learning-based joint source-channel coding (JSCC) method according to claim 4.

19. A non-transitory computer-readable storage medium, wherein the non-transitory computer-readable storage medium stores a computer program, and the computer program is invoked and executed by a computer to implement the meta-learning-based joint source-channel coding (JSCC) method according to claim 5.

20. A non-transitory computer-readable storage medium, wherein the non-transitory computer-readable storage medium stores a computer program, and the computer program is invoked and executed by a computer to implement the meta-learning-based joint source-channel coding (JSCC) method according to claim 6.
